(19) United States
(12) Patent Application Publication
(10) Pub. No.: US 2005/0223342 A1
(43) Pub. Date: Oct. 6, 2005

(54) Method of navigating in application views, electronic device, graphical user interface and computer program product

(76) Inventors: Mikko Repka, Oulu (FI); Virpi Roto, Espoo (FI)

Correspondence Address: Crawford Maunu PLLC;Suite 390, 1270 Northland Drive, St. Paul, MN, 55120, US

(21) Appl. No.: 11/052,420

(22) Filed: Feb. 7, 2005

Related U.S. Application Data
(63) Continuation-in-part of application No. 10/813,222, filed on Mar. 30, 2004.

(51) Int. Cl. G06F 3/00; G09G 5/00

(52) U.S. Cl. 715/851; 715/854; 715/808; 715/809; 715/784; 715/768; 715/790; 715/793; 715/794; 715/781; 715/797; 715/800; 715/769; 345/173; 345/660

(57) ABSTRACT

The invention relates to a method of navigating in application views of an electronic device, to an electronic device, to a graphical user interface, and to a computer program product. The electronic device is configured to: display an initial application view on the display, provide a floatable navigation area displayed at least partly over the application views on the display, the floatable navigation area comprising navigation blocks for controlling given software functions, detect a selection of a given navigation block indicated by the input device, perform software functions associated with the selected navigation block once the selection of said navigation block is detected, and to display a current application view on the basis of the performed software functions.

### RELATED APPLICATIONS

This is a continuation-in-part of application Ser. No. 10/813,222, filed Mar. 30, 2004, the content of which is incorporated herein by reference in its entirety.

### BACKGROUND OF THE INVENTION

1. Field of the Invention

The invention relates to a method of navigating in application views of an electronic device, to an electronic device for navigating in application views, to a graphical user interface for navigating in application views shown on a display of an electronic device, and to a computer program product.

2. Description of the Related Art

The significance of different displays, for example, touch screens, is becoming more and more important in portable electronic devices. The browsing capabilities of these devices are improving. Portable devices are more and more used when navigating in different application views shown in the devices, for example. Browsing on the Internet is one example of where the usability of a display is critical. However, the sizes of different portable electronic devices are limited, and therefore also the sizes of the displays used in such devices are usually far from corresponding displays used in personal computers, for example. Due to the limited sizes of the displays, the users need to scroll a lot when navigating on the Internet, for example. Small display sizes also lead to smaller fonts, which in turn leads to using zooming features of the devices.

Different mouse gestures are known, for example, dragging the mouse in given directions may result in predetermined browsing functions. However, these hand-held locators are difficult or even impossible to use in mobile situations.

The scroll bars used in known systems are often difficult to tap on, and especially when the display is small. The usability of such scroll bars is even poorer in mobile situations, in moving vehicles, for example. The horizontal and vertical scroll bars also cover up some space of the display. Also the functions of zooming in and out, for example, are usually quite difficult to use. To be able to zoom in to or out of an Internet document, for example, the user may have to first choose the appropriate zooming function by using various menus and menu bars.

### SUMMARY OF THE INVENTION

According to an aspect of the invention, there is provided a method of navigating in application views of an electronic device, the electronic device comprising a display for showing application views and an input device. The method comprises displaying an initial application view on the display, providing a floatable navigation area displayed at least partly over the application views on the display, the floatable navigation area comprising navigation blocks for controlling given software functions, detecting a selection of a given navigation block indicated by the input device, performing software functions associated with the selected navigation block once the selection of said navigation block is detected, and displaying a current application view on the basis of the performed software functions.

According to another aspect of the invention, there is provided an electronic device for navigating in application views, the electronic device comprising a control unit for controlling functions of the electronic device, a display for showing application views coupled to the control unit, and an input device for giving control commands for navigating, coupled to the control unit. The control unit is configured to: display an initial application view on the display, provide a floatable navigation area displayed at least partly over the application views on the display, the floatable navigation area comprising navigation blocks for controlling given software functions, detect a selection of a given navigation block indicated by the input device, perform software functions associated with the selected navigation block once the selection of said navigation block is detected, and display a current application view on the basis of the performed software functions.

According to an embodiment of the invention, there is provided a graphical user interface for navigating in application views shown on a display of an electronic device, the graphical user interface comprising: an initial application view displayed on the display, a floatable navigation area displayed at least partly over the application view, the floatable navigation area comprising navigation blocks for controlling given software functions, and a current application view displayed on the display on the basis of performed software functions associated with a detected selected navigation block.

According to another embodiment of the invention, there is provided a computer program product encoding a computer process for providing navigating in an application view of an electronic device, the computer process comprising: displaying an initial application view on the display, providing a floatable navigation area displayed at least partly over the application views on the display, the floatable navigation area comprising navigation blocks for controlling given software functions, detecting a selection of a given navigation block, performing software functions associated with the selected navigation block once the selection of said navigation block is detected, and displaying a current application view on the basis of the performed software functions.

According to an embodiment of the invention, there is provided an electronic device for navigating in application views, the electronic device comprising controlling means for controlling functions of the electronic device, displaying means for showing application views, and input means for giving control commands for navigating. The controlling means being further configured to: display an initial application view on a display, provide a floatable navigation area displayed at least partly over the application views on the display, the floatable navigation area comprising navigation blocks for controlling given software functions, detect a selection of a given navigation block indicated by the input means, perform software functions associated with the selected navigation block once the selection of said navigation block is detected, and display a current application view on the basis of the performed software functions.

The embodiments of the invention provide several advantages. Navigating in application views is carried out by using a single tool. Also, the user can customize the tool. Also, more space is saved in the display of the portable electronic device. Further, from the point of view of the user, the invention is quickly understandable and easy to learn and use.

### BRIEF DESCRIPTION OF THE DRAWINGS

In the following, the invention will be described in greater detail with reference to preferred embodiments and the accompanying drawings, in which

FIG. 1 shows an example of an electronic device;

FIGS. 2A and 2B illustrate examples of user interfaces of the invention, and

FIG. 3 shows an example of a method of navigating in application views in a user interface of an electronic device.

### DETAILED DESCRIPTION OF THE PREFERRED EMBODIMENTS

The embodiments of the invention are applicable to electronic devices, such as a mobile station used as a terminal in telecommunication systems comprising one or more base stations and terminals communicating with the base stations, for example. The device may be used for short-range communication implemented with a Bluetooth chip, an infrared or WLAN connection, for example. The electronic device is, for example, a portable telephone or another device including telecommunication means, such as a portable computer, a personal computer, a handheld computer or a smart telephone. The portable electronic device may be a PDA (Personal Digital Assistant) device including the necessary telecommunication means for establishing a network connection, or a PDA device that can be coupled to a mobile telephone, for instance, for a network connection. The portable electronic device may also be a computer or PDA device including no telecommunication means.

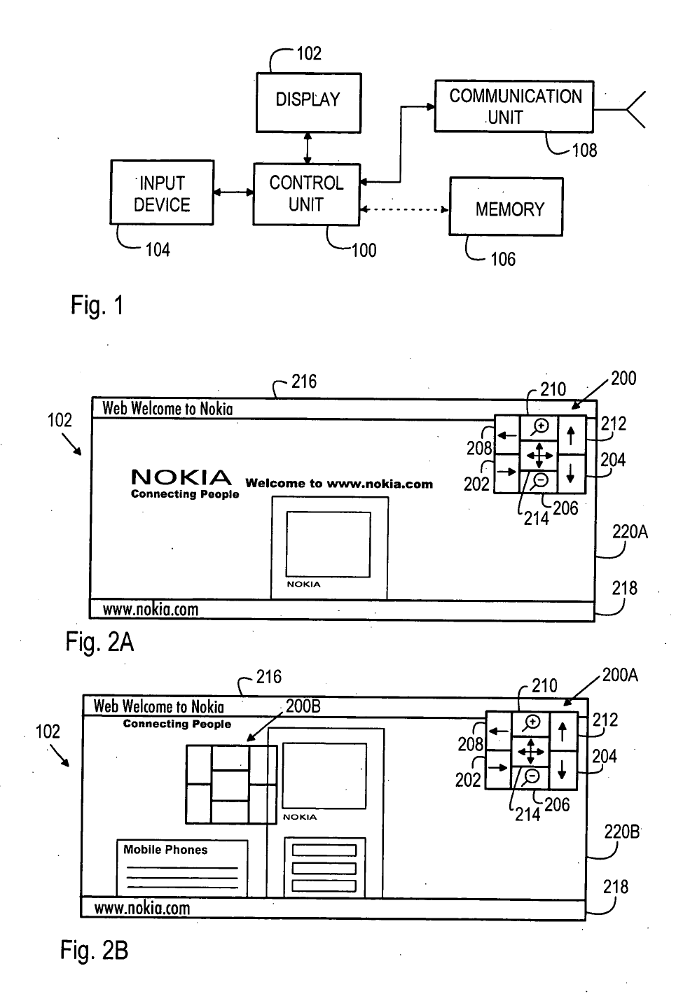

FIG. 1 shows a block diagram of the structure of an electronic device. A control unit 100, typically implemented by means of a micro-processor and software or separate components, controls the basic functions of the device. A user interface of the device comprises an input device 104 and a display 102, such as a touch screen implemented by manners known per se. In addition, the user interface of the device may include a loudspeaker and a keypad part. Depending on the type of the device, there may be different and a different number of user interface parts. The device of FIG. 1, such as a mobile station, also includes communication means 108 that implement the functions of a mobile station and include speech and channel coders, modulators and RF parts. The device may also comprise an antenna and a memory 106.

The functions of the device are controlled by means of the input device 104, such as a mouse, a hand-held locator operated by moving it on a surface. When using a mouse, for example, a sign or a symbol shows the location of a mouse cursor on the display 102 and often also the function running in the device, or its state. It is also possible that the display 102 itself is the input device 104 achieved by means of a touch screen such that the desired functions are selected by touching the desired objects visible on the display 102. A touch on the display 102 may be carried out by means of a pen, a stylus or a finger, for example. The input device 104 can also be achieved by using eye tracking means where detection of eye movements is used in interpreting certain control commands.

The control unit 100 controls the functions of the user interface and is connected to the display 102 and configured to show different application views on the display 102. The control unit 100 receives control commands from the input device 104. The input device 104 is configured to give control commands for navigating in application views shown on the display 102. The application views may be views into different web pages from the Internet, views from any application programs run in the device or any other application views that may be shown on the display 102. The navigating or browsing the application views may include scrolling the application view horizontally or vertically, zooming in to the application view to get a better view of the details of the application view or zooming out from the application view to get a more general view of the whole application view.

The navigating function operates such that the desired functions, such as scrolling or zooming, are first selected by means of the input device 104. Then, the control unit 100 interprets the detected selections, performs given software functions based on thereon and, as a result of the performed software functions, displays a given application view on the display 104.

In an embodiment of the invention, the control unit 100 first displays an initial application view on the display 102. The control unit 100 is configured to provide a floatable navigation area displayed at least partly over the application view on the display 102. The floatable navigation area comprises navigation blocks for controlling given software functions. The control unit 100 detects a selection of a given navigation block indicated by the input device 104. The selection may be detected on the basis of a touch on the display 102, for example. Alternatively, the selection may be detected by means of the input device 104, such as a mouse or a pen.

According to an embodiment of the invention, the control unit 100 is configured to perform software functions associated with the selected navigation block once the selection of said navigation block is detected. Finally, the control unit 100 is configured to display a current application view based on the performed software functions.

The initial application view may be a partial view into an Internet page, and the current application view after a scrolling function may be a view into another part of the Internet page, for example. The current application view may also be a view into the Internet page after the control unit 100 has performed a zooming function.

The control unit 100 continues to detect control commands indicated by the input device 102, and to detect selections of given navigation blocks. It is possible that the floatable navigation area is displayed automatically partly over the application view on the display 102 when a given application program displaying the application views is opened. It is also possible that the floatable navigation area is opened separately by using an icon or a menu function or by tap-based activation.

Let us next study embodiments of the invention by means of FIGS. 2A and 2B. FIGS. 2A and 2B show displays 104 of an electronic device, such as a PDA device. The FIGS. 2A and 2B illustrate graphical user interfaces in an embodiment of the invention.

A display 102 is divided into different areas, each area having specific functions. Application views are shown in the largest areas 220A and 220B, for example. There may be different bars 216, 218 for displaying different information or menus on the display 102.

In an embodiment, the floatable navigation areas 200, 200A, 200B are in the form of squares in FIGS. 2A and 2B. The floatable navigation areas 200, 200A, 200B may also be of any other shape than that of a square, such as a circle, for example. The floatable navigation areas 200, 200A, 200B comprise navigation blocks 202, 204, 206, 208, 210, 212, 214 for controlling given software functions. In these examples, the navigation blocks 202 and 208 control horizontal scrolling of the application view and the navigation blocks 204 and 212 control vertical scrolling of the application view. The navigation blocks 206 and 210 control zooming in and zooming out in this example. It is possible that tapping a pen down on a given navigation block 202, 204, 208, 212 for scrolling results in scrolling to the desired direction by a single predetermined step. Holding the pen down on the navigation block 202, 204, 208, 212 may repeat the functionality. Accordingly, tapping a pen down on a given navigation block 206, 210 for zooming results in changing the zoom level by a single predetermined step, and holding the pen down repeats the functionality.

The number of navigation blocks 202, 204, 206, 208, 210, 212, 214 may be different than in this example. There may also be control functions for the navigation blocks 202, 204, 206, 208, 210, 212, 214 other than those in these examples. Further, it is possible that there is only one navigation block for both horizontal and vertical scrolling, for example. Thus, using one half of the navigation block may carry out the horizontal scrolling and using the other half of the navigation block carries out the vertical scrolling. The main point in this embodiment is that all the necessary navigation blocks reside in the same area, that is, in the floatable navigation area 200, 200A, 200B.

In an embodiment of the invention, the floatable navigation area 200, 200A, 200B comprises a control block 214. In FIGS. 2A and 2B, the control block 214 is in the middle of the floatable navigation area. The control block 214 is for changing the location of the floatable navigation area 200, 200A, 200B, for example. The location of the floatable navigation area 200, 200A, 200B may be changed for example by dragging and dropping the floatable navigation area 200, 200A, 200B with the help of the control block 214. Tapping on the control block 214 and holding the pen down while dragging may move the floatable navigation area to a desired location. For example, in FIG. 2B, the location of the floatable navigation area 200A is changed to a location of the floatable navigation area 200B. It is also possible that the changed location remains in the memory and the floatable control area 200A is next displayed in the changed location.

The appearance of the floatable navigation area 200, 200A, 200B may be set as desired. In the example of FIG. 2A, the navigation blocks 202, 204, 206, 208, 210, 212, 214 for different functions are marked with individual icons, such as arrows up and down, for navigation blocks 212, 204 for vertical scrolling, arrows left and right for navigation blocks for horizontal scrolling 202, 208, magnifiers for navigation blocks 206, 210 for zooming in or out, and crossed arrows for the control block 214. The navigation blocks 202, 204, 206, 208, 210, 212, 214 may also be marked with appropriate colors, text, drawings or fill effects. It is also possible that no icons are used and only the different colours are used to identify different functions of the navigation blocks 202, 204, 206, 208, 210, 212, 214. For example, different function groups, such as scrolling, zooming and moving, may have their own colors in addition to icons like arrows and magnifiers.

The floatable navigation area 200, 200A, 200B may also be set to appear in a “ghost mode”, meaning for example that all the icons are removed and only colors are used to indicate different navigation blocks. The whole floatable navigation area 200, 200A, 200B may be semi-transparent, that is, the contents below the floatable navigation area 200, 200A, 200B are visible. The level of transparency may also be adjusted: Thus, the floatable navigation area 200, 200A, 200B does not cover so much of the application view shown on the display 102. It is also possible that no colours, arrows or magnifiers are shown such that only some or all outlines of the different navigation blocks 202, 204, 206, 208, 210, 212, 214 are visible. As an example of the “ghost mode”, FIG. 2B shows the floatable navigation area 200B in a “ghost mode”. The application view 220B can be seen through the floatable navigation area 200B. Further, there are only outlines of the navigation blocks 202, 204, 206, 208, 210, 212, 214 marking the locations of the navigation blocks of the floatable navigation area 200B. Of course, it is possible that the “ghost mode” is used with different icons, such as arrows, magnifiers and/or colors. Thus, the application view under the floatable navigation area 200, 200A, 200B is also seen through the semi-transparent floatable navigation area.

In FIG. 2A, the graphical user interface of the embodiment comprises an initial application view 220A that is displayed on the display 102. The application view 220A is, for example, a view into a web page on the Internet. The floatable navigation area 200 is displayed at least partly over the initial application view 220A. The location and size of the floatable navigation area 200 may be determined by using the user interface of the device, for example. It is possible that each time an application view is opened, the floatable navigation area 200 is displayed in a given location, for example, in the upper right corner of the display 104. The location may at any time be changed by using the control block 214. Pressing or touching the control block 214 with a pen, for example, and moving the pen along the surface of the display 104 may result in changing the location of the floatable navigation area 200. The size of the floatable navigation area 200 may also be set appropriately, for example, according to the needs of individual users of the device. The user may choose between a large and a small floatable navigation area 200, 200A, 200B, for example. As the use of the method becomes familiar, the user may wish to make the floatable navigation area 200, 200A, 200B smaller and less visible. Thus, the smaller size and a “ghost mode” may be selected to make the floatable navigation area 200, 200A, 200B quite invisible, yet still usable.

In the example of FIG. 2A, the navigation block 204 is next selected. The user, for example, wishes to navigate the view to the web page by scrolling the page downwards. Thus, the navigation block 204 that controls the scrolling down function is selected. The selection of the navigation block 204 may be performed by using any suitable input device. Once the selection of the navigation block 204 has been detected, a current application view 220B illustrated in FIG. 2B is displayed. The amount of scrolling down may depend on how long a pen is pressed on the navigation block 204, for example. If only a single touch is detected on the navigation block 204, only a predetermined step is scrolled down. Further, if the pen is continuously held down on the navigation block 204, the scrolling down continues as long as the pen stays on the navigation block 204. It is also possible that pressing the pen on the navigation block 204 for a predetermined period of time results in an increase in the speed of scrolling down.

Accordingly, if the user wishes to zoom the application views shown on the display 102, navigation blocks 206, 210 for zooming are selected. Once the selection of the navigation block 206, 210 for zooming has been detected, a current application view zoomed according to the detected selected navigation block is shown. If a pen is continuously held down on the navigation block 206, 210 for zooming, the zooming function continues. It is also possible that pressing the pen on the navigation block 206, 210 for a given time may result in an increase in the speed of zooming accordingly. In an embodiment, it is also possible that the amount of pressure detected at a site of a navigation block 202, 204, 206, 208, 210, 212 defines the speed of scrolling or the level of zooming. The amount of pressure may be detected based on a touch screen or a pressure sensitive pen used with the user interface of an embodiment, for example.

In another embodiment, it is possible to use a dragging function after a selection of a given navigation block 202-214. The input device may be a touch screen and a stylus, for example, and the user may select a given navigation block 202-214 by first touching the touch screen with the stylus. Then the stylus may be moved along the surface of the touch screen thus resulting a dragging function associated to the given navigation block 202-214. Thus, the software functions associated with the selected navigation block 202-214 are performed on the basis of the detected drag function on the given navigation block. In an embodiment, the software functions performed are based on the detected amount of the drag function on the given navigation block. In another embodiment, the software functions performed are based on the detected speed of the drag function on the given navigation block. Thus, the direction and the length of the drag function may define attributes for the software functions. The software functions may be accelerated if the user drags farther away from the original point.

In an embodiment, it is possible that the whole area of the display is considered as the floatable navigation area 200 or that there are number of floatable navigation areas 200, 200A, 200B shown on the display. Thus, the navigation blocks 200-212 may in fact reside anywhere on the display 102 area. The user may only need a few navigation blocks 200-212 on a regular basis and only those navigation blocks 200-212 that are frequently used may be visible on the display 102. It is also possible that given navigation blocks 200-212 are situated on different parts of the display 102.

In an embodiment, the dragging function has different effects depending on the given navigation block 200-212 to which the dragging function is directed. Some examples of how different control functions, such as tap, tap & hold or drag, may be used in navigating in application views are shown in the following tables 1-6. The control functions may be made, for example, by using a pen or a stylus with a touch screen as an input device. The right part of each table shows different software functions resulting from given control functions directed to the given navigation blocks. The idea is to provide the users a basic set of floating blocks on an active content area: scroll, zoom, page navigation and search. Whenever the user taps or drags the navigation blocks, the functions described in the following tables may be executed. The directions and lengths of the drag functions define attributes for the functions and the action is accelerated when user drags farther away from the original point.

TABLE 1
Navigation block for scrolling

| | |
|---|---|
| Tap: | Moving to a previous position on the application view (or same |
| | as in tap & hold). |
| Tap | Bringing up a zoom & scroll dialog that provides a miniature view |
| & | of a page and a rectangle (corresponding the new view) that |
| Hold: | may be moved and resized. |
| Drag: | The direction of drag may define the scrolling direction. Dragging |
| | down results in showing more content below the current view. |
| | Page may be scrolled to any direction; the scrolling direction is |
| | the same as a current angle between a scroll starting point |
| | (navigation block) and a stylus, for example. The view is scrolled |
| | smoothly until a stylus is lifted off. The farther the stylus is |
| | moved from the navigation block, the faster the scroll may be. |
| | The view never scrolls over the page. If the content is not wider |
| | than the display, only up and down scrolling is possible. |

TABLE 2
Navigation block for zooming in and out

| | |
|---|---|
| Tap: | Zooming a predetermined step towards the centre of the current |
| | view. |
| Tap | Bringing up a zoom & scroll dialog that provides a miniature view |
| & | of the page and a rectangle (corresponding the new view) that |
| Hold: | can be moved and resized. |
| Drag: | The direction of the drag defines whether the view is zoomed in |
| | or out. Dragging right or up zooms in, and dragging left or down |
| | zooms out. The view is zoomed in smoothly until stylus is lifted |
| | off. The farther the stylus is moved, the faster the zoom is. |
| | Continuing the dragging to the other side of the navigation |
| | block changes zooming direction. |

TABLE 3
Navigation block for page navigation

| | |
|---|---|
| Tap: | Going back to the previous page. |
| Tap | Bringing up a history dialog with a list of previously visited pages. |
| & | Also possible pages in a forward list may be shown here. |
| Hold: | |
| Drag: | The direction of drag defines the navigation direction. Dragging |
| | right or down results is jumping forward, and dragging left or up |
| | results in jumping backwards. More pages are shown until stylus |
| | is lifted off. The farther the stylus is moved from the navigation |
| | block the faster the jumping is. If there are several windows |
| | open, vertical drag results in jumping between the windows. The |
| | window from where the current window was opened is shown |
| | when the user drags up, and the window opened later is shown |
| | when dragging down. Again, the farther the stylus is moved the |
| | faster the windows will change. |

TABLE 4
Navigation block for search

| | |
|---|---|
| Tap: | Executing a previous search again (=find text), if a search on the |
| | current page has previously been defined in this browsing session. |
| | Trying to find a given keyword from the current page, if a search |
| | on the Web has been defined in this browsing session. |
| | Bringing up a search dialog with options for searching a given |
| | keyword either from the Web or from the current page, if no |
| | search has been executed in this browsing session. |
| | If browsing session is always open, the memory of the previous |
| | search lasts for a determined period of time (for example one |
| | hour). After this period of time tapping results in popping up a |
| | search dialog. |
| Tap | Bringing up a search dialog with options for searching a given |
| & | keyword either from the Web or from the current page. |
| Hold: | |
| Drag: | Re-executing a search when a search on the current page in this |
| | browsing session has previously been defined. The direction of |
| | drag defines the direction of search. There may be at least two |
| | directions (previous, next). The text that has been found is |
| | highlighted. The speed of jumping to the next matching text |
| | is defined by the distance of the stylus from the navigation |
| | block. |
| | Trying to find a given keyword from the current page, if a search |
| | on the WEB has previously been defined in this browsing session. |
| | Finding and highlighting next hyperlink from the direction of drag, |
| | if no search has been executed in this browsing session. |
| | If browsing session is always open, the memory of the previous |
| | search lasts for a determined period of time (for example one |
| | hour). After this period drag initiates a hyperlink search. |

TABLE 5
Navigation block for zooming in

| | |
|---|---|
| Tap: | Zooming a predetermined step towards the centre of the view. |
| Tap | Zooming in smoothly towards the centre of the view. |
| & | |
| Hold: | |
| Drag: | Scrolling the view while zooming towards the centre of the |
| | changing view. The direction of drag defines the scrolling |
| | direction. Dragging down results in showing more content |
| | from below the current view. The page may be scrolled to |
| | any direction. The scrolling direction is the same as the |
| | current angle between the scroll starting point (navigation |
| | block) and the stylus. The view is zoomed and scrolled |
| | smoothly until the stylus is lifted off. The farther the |
| | stylus is moved form the navigation block, the faster |
| | the scrolling is. |

TABLE 6
Navigation block for zooming out

| | |
|---|---|
| Tap: | Zooming a predefined step out from the centre of the current |
| | view. |
| Tap | Zooming out smoothly from the centre of the view. |
| & | |
| Hold: | |
| Drag: | Scrolling the view while zooming. The direction of drag defines |
| | the scrolling direction. Dragging down results in showing more |
| | content from below the current view. The page may be scrolled |
| | to any direction. The scrolling direction is the same as the current |
| | angle between the scroll starting point (navigation block) |
| | and the stylus. The view is zoomed and scrolled smoothly until |
| | the stylus is lifted off. The farther the pen is moved from the |
| | navigation block, the faster the scrolling is. |

New ways of scrolling, zooming, navigating between pages and searching efficiently with the floatable navigation control was shown in the previous tables 1-6. Because of screen space limitations, for example, mobile Web users wish to utilize the full screen when viewing a Web page. It is essential to provide the users a full screen mode in which browser controls or large scroll bars do not cover the page content. Still, the most important viewing and navigation control blocks should be easily accessible.

The examples shown in the previous tables 1-6 provide possibilities to modelessly zoom or scroll the application views and navigate backwards and forward with a single gesture of a stylus, for example. Using floating controls is most efficient in a Full Screen mode. The acceleration function allows very efficient interaction for the most important browser functions. Instead of scrollbars that provide only linear movement, the users can scroll to any direction freely. Instead of scrollbars that take up screen space, the users may utilize a full screen space (only tiny position indicators are needed). Unlike in panning where the user must grab one point on the page and drag it to another point, the user can scroll over several screens with a single drag. Also very easy toggling between zooming in and out is provided. The acceleration functions described in these examples can be used in other applications also.

In tables 5 and 6, embodiments where separate navigation blocks for zooming in and zooming out were provided. The reason for this embodiment is to allow simultaneous zoom and scroll functions. Providing separate controls for zooming in and out is also more intuitive for the end users than a single control. Only a single drag is needed to zoom the application view to a desired point. User may also zoom to areas outside the original view. Also an easy way of zooming out with one tap is provided (with only one zooming block for both zooming in and out, tapping function only zooms in).

In an embodiment, also other control functions may be quickly selected by using the floatable navigation area 200, 200A, 200B. For example, pressing a secondary mouse button on a given navigation block 202, 204, 206, 208, 210, 212, 214 may result in opening a selection list or a menu where different control functions may be selected. If a touch screen or a pressure sensitive pen is used, a pen down on the control block 214 and holding the pen without moving may activate a given control function, such as opening of the selection list. Different topics on the selection lists or menus may be related to the floating navigation area 200, 200A, 200B, to the navigation blocks 202, 204, 206, 208, 210, 212, 214, to browsing functions and different settings. All the settings and functions that are needed are easily reachable by using such selection lists. Examples of the control functions that may be included in the selection lists include toggling between a full screen and a normal view, hiding the floatable navigation area 200, 200A, 200B, selecting the ghost mode, setting the size and appearance of the floatable navigation area 200, 200A, 200B, and so on. Selecting a given topic from the selection list results in performing the function in question and then closing the selection list, for example. Also, tapping outside the selection list may cancel the action and close the selection list.

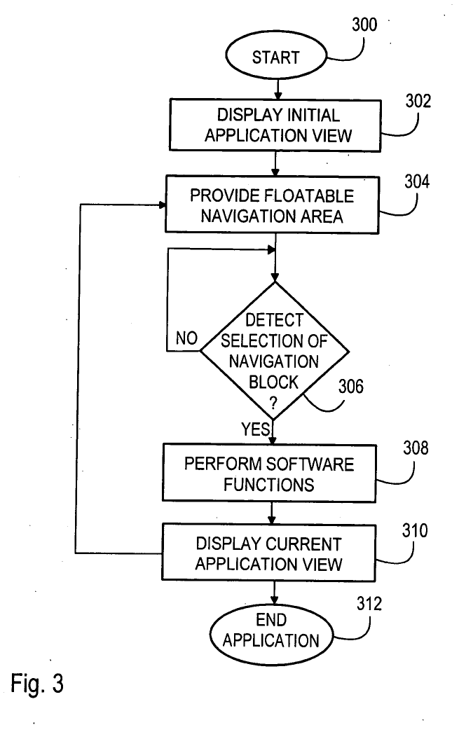

FIG. 3 shows an example of a method of navigating in application views in a user interface of an electronic device.

The method starts is 300. In 302, an initial application view is displayed on the display. In 304, a floatable navigation area is displayed on the display at least partly over the application view. The floatable navigation area may be displayed automatically when the application view is shown on the display, for example. It is also possible that the floatable navigation area is first shown as an icon on the display, is activated from a menu or on the basis of a tap based activation on screen, and is selected when needed. In 306, if a selection of a navigation block is detected, 308 is entered. If no selections of navigation blocks are detected, the initial application view remains with the floatable navigation area covering a part of the application view.

In 308, software functions associated with the selected navigation block are performed based on the detection of the selected navigation block. In 310, a current application view is displayed based on the performed software functions. The method may continue by repeating the steps from 304 to 310 until the application is closed or the device is shut down. The method ends in 312.

Even though the invention has been described above with reference to an example according to the accompanying drawings, it is clear that the invention is not restricted thereto but can be modified in several ways within the scope of the appended claims.

1. A method of navigating in application views of an electronic device, the electronic device comprising a display for showing application views and an input device, the method comprising:
displaying an initial application view on the display;
providing a floatable navigation area displayed at least partly over the application views on the display, the floatable navigation area comprising navigation blocks for controlling given software functions;
detecting a selection of a given navigation block indicated by the input device by detecting a drag function on the given navigation block;
performing software functions associated with the selected navigation block once the selection of said navigation block is detected and on the basis of the detected drag function on the given navigation block; and
displaying a current application view on the basis of the performed software functions.

2. The method of claim 1, wherein performing the software functions comprises performing the software functions based on at least one of the following: an amount of the detected drag function, a speed of the detected drag function, a direction of the detected drag function.

3. The method of claim 1, the method further comprising providing a control block in the floatable navigation area for changing the location of the floatable navigation area, and changing the location of the floatable navigation area on the basis of detected control commands from the control block.

4. The method of claim 1, the method further comprising providing the floatable navigation area when the initial application view is opened in the display.

5. The method of claim 1, the step of performing software functions comprising scrolling the initial application view horizontally or vertically to produce a current application view.

6. The method of claim 1, the step of performing software functions comprising zooming in to or out of the initial application view to produce the current application view.

7. The method of claim 1, the method further comprising displaying the floatable navigation area semi-transparently over an application view.

8. The method of claim 1, the method further comprising displaying outlines of the floatable navigation area over the application views.

9. The method of claim 1, the method further comprising displaying outlines of the navigation blocks over the application views.

10. The method of claim 1, wherein the input device comprises a touch screen and the step of detecting the selection of a given navigation block comprises detecting one or more touches on the given navigation block indicated by the touch screen.

11. The method of claim 9, the step of performing the software functions being based on the detected one or more touches on the given navigation block indicated by the touch screen.

12. An electronic device for navigating in application views, the electronic device comprising a control unit for controlling functions of the electronic device, a display for showing application views coupled to the control unit, and an input device for giving control commands for navigating, coupled to the control unit, the control unit being configured to:
display an initial application view on the display;
provide a floatable navigation area displayed at least partly over the application views on the display, the floatable navigation area comprising navigation blocks for controlling given software functions;
detect a selection of a given navigation block indicated by the input device by detecting a drag function on the given navigation block;
perform software functions associated with the selected navigation block once the selection of said navigation block is detected and on the basis of the detected drag function on the given navigation block; and
display a current application view on the basis of the performed software functions.

13. The electronic device of claim 12, wherein the control unit is further configured to provide a control block in the floatable navigation area for changing the location of the floatable navigation area; and change the location of the floatable navigation area on the basis of detected control commands from the control block.

14. The electronic device of claim 13, wherein the control unit is further configured to perform the software functions based on at least one of the following: an amount of the detected drag function, a speed of the detected drag function, a direction of the detected drag function.
